(19) United States
(12) Patent Application Publication
(10) Pub. No.: US 2013/0241871 A1
(43) Pub. Date: Sep. 19, 2013

(54) TOUCH PANEL AND MANUFACTURING METHOD THEREOF

(71) Applicant: HANNSTAR DISPLAY CORP., NEW TAIPEI CITY (TW)

(72) Inventors: CHENG-CHUNG HUANG, TAOYUAN COUNTY (TW); JENG-MAW CHIOU, HSINCHU COUNTY (TW)

(73) Assignee: HANNSTAR DISPLAY CORP., NEW TAIPEI CITY (TW)

(21) Appl. No.: 13/803,888

(22) Filed: Mar. 14, 2013

(30) Foreign Application Priority Data
Mar. 16, 2012 (CN) 201210070923.5

(51) Int. Cl. G06F 3/044

(52) U.S. Cl. CPC G06F 3/044
USPC 345/174; 427/555

(57) ABSTRACT

There is provided a touch panel including a substrate, at least one laser blocking layer and at least one transparent conductive layer. The at least one laser blocking layer is formed on at least one of a first surface and a second surface of the substrate. The at least one transparent conductive layer is formed on at least one of the first surface and the second surface of the substrate, and a plurality of etching trenches having irregular edges are formed on the transparent conductive layer using UV laser.

### CROSS REFERENCE TO RELATED APPLICATION

This application claims the priority benefit of Chinese Patent Application Number 201210070923.5, filed on Mar. 16, 2012, the full disclosure of which is incorporated herein by reference.

### BACKGROUND

1. Field of the Disclosure

This disclosure generally relates to a touch control device and, more particularly, to a touch panel manufactured by laser etching and a manufacturing method thereof.

2. Description of the Related Art

Due to its excellent operational convenience, the touch panel has gradually replaced peripheral devices such as the mouse and the keyboard used in traditional interactive systems. The touch panel is especially suitable for portable electronic devices including cell phones, satellite navigators and personal digital assistances.

For example a capacitive touch panel is generally manufactured by respectively forming a transparent electrode on two surfaces of a glass substrate and by removing a part of the transparent electrode through a photolithography and etching process so as to form a desired electrode pattern. However, in the photolithography and etching process a mask is covered on the transparent electrode at first and then an exposure and developing process is performed. After the exposure and developing process is accomplished, a wet etching process is performed successively so as to form the desired electrode pattern, wherein this electrode pattern is formed through complex processes and waste liquid is generated in the process. In addition, each mask can only be used to form one type of electrode pattern and different masks are necessary to form different electrode patterns. Therefore, the conventional manufacturing method of the touch panel has the problem of high manufacturing cost.

Accordingly, the present disclosure further provides a touch panel manufactured by laser etching and a manufacturing method thereof that may accurately control a laser light beam to pattern etching the transparent electrode such that the manufacturing cost and complexity can be significantly reduced since conventional photolithography and etching process is no longer necessary.

### SUMMARY

It is an object of the present disclosure to provide a touch panel and a manufacturing method thereof that utilize laser etching to reduce the manufacturing cost and complexity.

It is another object of the present disclosure to provide a touch panel and a manufacturing method thereof that has a laser blocking layer formed on a substrate to prevent the components on one surface of the substrate from being damaged when the other surface of the substrate is being laser etched.

The present disclosure provides a manufacturing method of a touch panel including the steps of: providing a substrate; forming a laser blocking layer on at least one of a first surface and a second surface of the substrate; forming a transparent conductive layer on at least one of the first surface and the second surface of the substrate; and patterning the transparent conductive layer by using UV laser etching to form a transparent conductive electrode.

The present disclosure further provides a touch panel including a substrate, at least one laser blocking layer and at least on transparent conductive layer. The at least one laser blocking layer is formed on at least one of a first surface and a second surface of the substrate. The at least one transparent conductive layer is formed on at least one of the first surface and the second surface of the substrate, and a plurality of etching trenches having irregular edges are formed on the transparent conductive layer using UV laser.

In one aspect, the etching trenches are extending along an identical direction in parallel with each other so as to form parallel transparent conductive lines on the transparent conductive layer.

In the touch panel of the present disclosure and the manufacturing method thereof, the laser blocking layer may be formed only on the first surface and the transparent conductive layer may be formed on the laser blocking layer of the first surface or on the second surface; that is, the transparent conductive layer and the laser blocking layer may be formed on the same surface or different surfaces of the substrate.

In the touch panel of the present disclosure and the manufacturing method thereof, the laser blocking layer may be formed only on the first surface and the transparent conductive layer may be formed on the laser blocking layer of the first surface and on the second surface.

In the touch panel of the present disclosure and the manufacturing method thereof, the laser blocking layer is formed on the first surface and the second surface, and the transparent conductive layer is formed on the laser blocking layer of the first surface and on the laser blocking layer of the second surface.

### BRIEF DESCRIPTION OF THE DRAWINGS

Other objects, advantages, and novel features of the present disclosure will become more apparent from the following detailed description when taken in conjunction with the accompanying drawings.

FIG. 1 shows a schematic diagram of the touch panel and manufacturing method thereof according to a first embodiment of the present disclosure.

FIGS. 2A and 2B show schematic diagrams of the etching trenches on the transparent conductive layer of the touch panel according to the embodiment of the present disclosure.

FIG. 3 shows a schematic diagram of the touch panel and manufacturing method thereof according to a second embodiment of the present disclosure.

FIG. 4 shows a schematic diagram of the touch panel and manufacturing method thereof according to a third embodiment of the present disclosure.

FIG. 5 shows a schematic diagram of the touch panel and manufacturing method thereof according to a fourth embodiment of the present disclosure.

FIG. 6 shows a flow chart of the manufacturing method of the touch panel according to the embodiment of the present disclosure.

### DETAILED DESCRIPTION OF THE EMBODIMENT

It should be noted that, wherever possible, the same reference numbers will be used throughout the drawings to refer to the same or like parts.

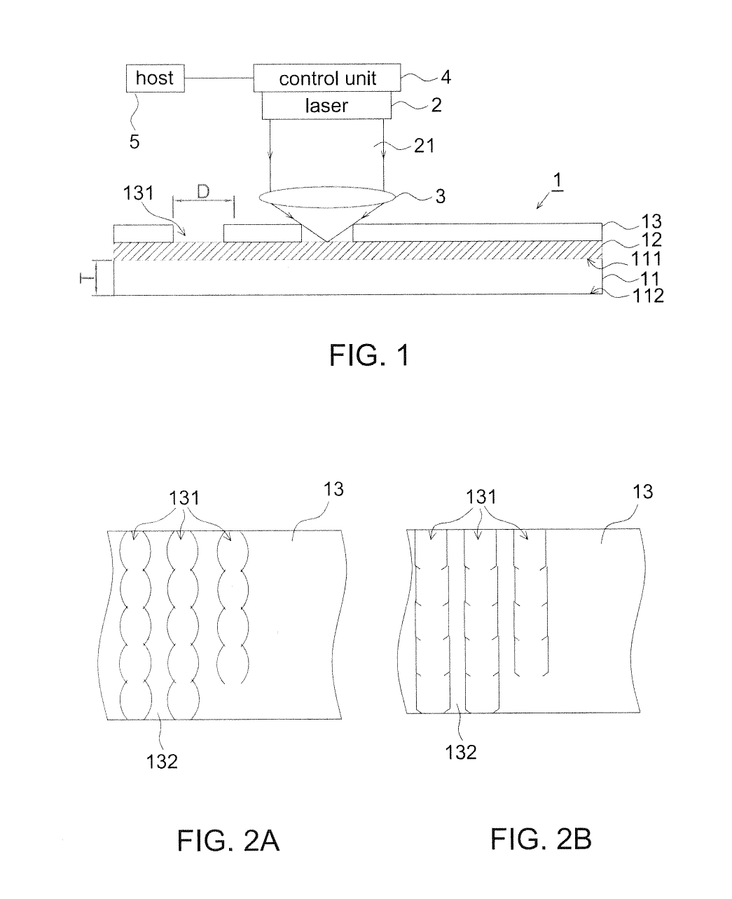

Referring to FIG. 1, it shows a schematic diagram of the touch panel and manufacturing method thereof according to a first embodiment of the present disclosure, wherein a laser 2 radiates UV laser beam 21 to etch a transparent conductive layer 13 on the touch panel 1 to form, form example transparent conductive lines of a touch control circuit. The UV laser beam 21 is preferably focused on or above the transparent conductive layer 13 by a lens (or lens set) 3 so as to perform laser etching thereby forming a plurality or etching trenches 131, wherein a width D of the etching trenches 131 is preferably between 20 μm and 100 μm and more preferably between 30 μm and 50 μm to fulfill the requirement of mass production. In addition, the laser 2 may be a pulse laser to form the etching trenches 131 having irregular edges on the transparent conductive layer 13 as shown in FIGS. 2A and 2B; that is, the UV laser beam 21 may generate a light dot having a circular shape, an elliptical shape, a rectangular shape or other shapes on the transparent conductive layer 13 after being focused by the lens 3 so as to etch the transparent conductive layer 13 and form, for example a plurality of parallel transparent conductive lines thereon, but not limited thereto.

A control unit 4 may be configured to control the laser 2 to form a desired electrode pattern on the transparent conductive layer 13, wherein said control unit 4 may be coupled to a host 5 and information of the desired electrode pattern may be previously stored in the host 5.

The touch panel 1 of the present embodiment may be a capacitive touch panel and include a substrate 11, at least one laser blocking layer 12 and at least one transparent conductive layer 13. The at least one laser blocking layer 12 is formed on at least one of a first surface 111 and a second surface 112 of the substrate 11, wherein the first surface 111 is opposite to the second surface 112. The at least one transparent conductive layer 13 is formed on at least one of the first surface 111 and the second surface 112 of the substrate 11, and a plurality of etching trenches 131 having irregular edges are formed on the transparent conductive layer 13 using UV laser. In each embodiment of the present disclosure, the substrate 11 may be, but not limited to, a soda glass substrate, an alkali free glass substrate, a polyethylene terephthalate (PET) substrate or a polyimide (PI) substrate, and preferably has a thickness T between 0.1 μm and 2 μm. The laser blocking layer 12 may be made of material such as SiOx, wherein a value of x may be configured to determine the upper limit and the lower limit of UV light wavelength to be blocked. According to a general wavelength range in laser etching, the laser blocking layer 12 may block UV light between 400 nm and 150 nm wavelength, and more preferably may block UV light between 300 nm and 200 nm wavelength. It is appreciated that the laser blocking layer 12 may be made of other materials capable of blocking UV light. In addition, a thickness of the laser blocking layer 12 is preferably between 100 and 10000 angstrom to allow visible light to be able to pass through.

In the first embodiment, the laser blocking layer 12 is formed only on the first surface 111 and the transparent conductive layer 13 is formed on the laser blocking layer 12 of the first surface 111. The laser blocking layer 12 is a UV light blocking layer and is preferably able to block (e.g. reflecting or absorbing) the UV light having a wavelength lower than 400 nm, and is more preferably able to block the UV light having a wavelength lower than 300 nm. In this manner, the UV laser beam 21 radiated by the laser 2 can only etch the transparent conductive layer 13 formed on the first surface 111 but can not damage other components (e.g. another transparent conductive layer) formed on the second surface 112. In addition, the laser blocking layer 12 further has the function of index matching between the substrate 11 and the transparent conductive layer 13 and the function of buffering to improve the combination therebetween. The laser blocking layer 12 may be formed by sputtering, coating or other processes on the substrate 11.

The transparent conductive layer 13 may be formed by sputtering, coating or other processes on the laser blocking layer 12, and the transparent conductive layer 13 may be made of materials such as Indium Tin Oxide (ITO), Fluorine Tin Oxide (FTO), transparent conductive oxide (TCO) or other transparent materials.

It should be mentioned that in the first embodiment the laser blocking layer 12 and the transparent conductive layer 13 may be formed on the second surface 112; that is, in this embodiment the laser blocking layer 12 and the transparent conductive layer 13 are formed on the same surface of the substrate 11.

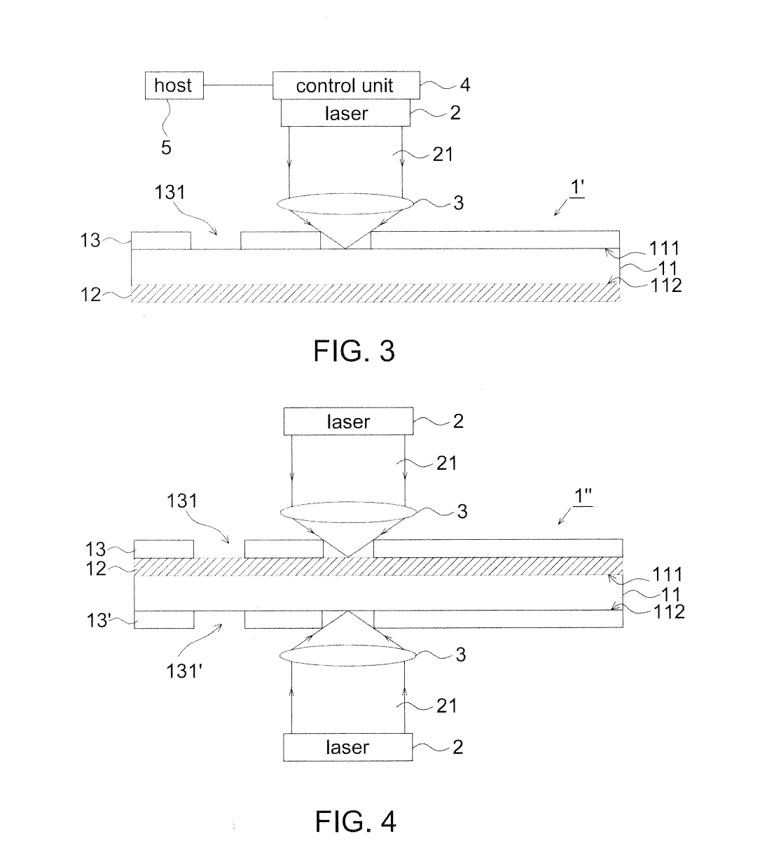

Referring to FIG. 3, it shows a schematic diagram of the touch panel 1′ and manufacturing method thereof according to a second embodiment of the present disclosure. The difference between the second embodiment and the first embodiment is that the laser blocking layer 12 and the transparent conductive layer 13 are formed on different surfaces of the substrate 11. For example in this embodiment, the laser blocking layer 12 is formed only on the second surface 112 and the transparent conductive layer 13 is formed on the first surface 111. The touch panel 1′ is similar to that of the first embodiment and thus details thereof are not repeated herein. In this manner, when the UV laser beam 21 is used to form the electrode pattern on the transparent conductive layer 13, as the laser blocking layer 12 is formed on the second surface 112, the UV laser beam 21 can not damage other components formed on the second surface 112, wherein said other components are formed on an exterior of the laser blocking layer 12 (e.g. the lower surface in FIG. 3).

Referring to FIG. 4, it shows a schematic diagram of the touch panel 1″ and manufacturing method thereof according to a third embodiment of the present disclosure. The difference between the third embodiment and the first embodiment is that the transparent conductive layer is formed on both the first surface 111 and the second surface 112 of the substrate 11. For example in this embodiment, the laser blocking layer 12 is formed only on the first surface 111 and a transparent layer 13 is formed on the laser blocking layer 12 of the first surface 111 and a transparent conductive layer 13′ is formed on the second surface 112. It is appreciated that the transparent conductive layers 13 and 13′ may be respectively formed on the laser blocking layer 12 and the second surface 112 using identical manufacturing processes. In the third embodiment, as two opposite surfaces of the substrate 11 respectively have the transparent conductive layers 13 and 13′, the transparent conductive layers 13 and 13′ have to be patterned sequentially or simultaneously. For example, it is able to use the laser 2 to sequentially pattern etch the transparent conductive layers 13 and 13′ or to use two sets of laser to simultaneously pattern etch the transparent conductive layers 13 and 13′. For example, it is able to form parallel transparent conductive lines extending along a first direction on the transparent conductive layer 13 and form parallel transparent conductive lines extending along the first direction or a second direction on the transparent conductive layer 13′, and a touch control device can be formed when the transparent conductive lines are electrically connected a proper driver IC, wherein the first direction may be perpendicular to the second direction. In addition, as the laser blocking layer 12 is also formed on the substrate 11, the components formed on the other surface will not be damaged no matter the transparent conductive layers 13 and 13′ being patterned by the laser 2 sequentially or simultaneously. It should be mentioned that the laser shown in FIG. 4 is also controlled by a control unit and a host which are omitted herein for simplification.

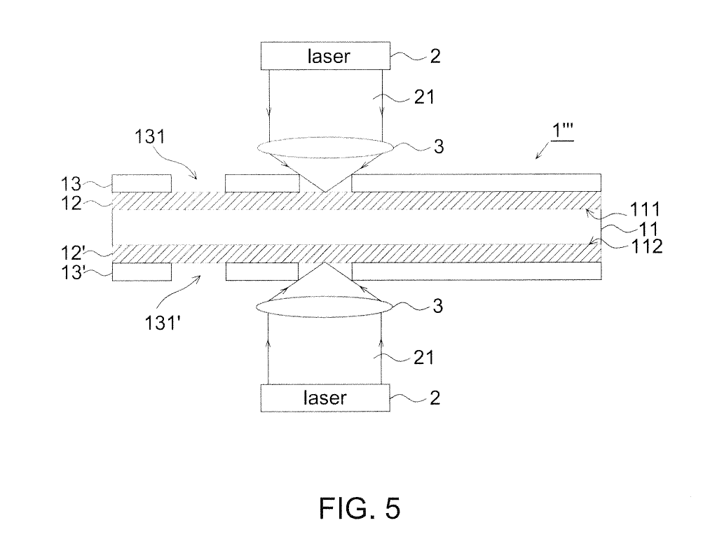

Referring to FIG. 5, it shows a schematic diagram of the touch panel 1′″ and manufacturing method thereof according to a fourth embodiment of the present disclosure. The difference between the fourth embodiment and the third embodiment is that the laser blocking layer is formed on the first surface 111 and the second surface 112 of the substrate 11. For example in this embodiment, a laser blocking layer 12 is formed on the first surface 11 and a laser blocking layer 12′ is formed on the second surface 112. A transparent conductive layer 13 is formed on the laser blocking layer 12 of the first surface 111 and a transparent layer 13′ is formed on the laser blocking layer 12′ of the second surface 112. It is appreciated that the laser blocking layer 12 and 12′ may be respectively formed on the substrate 11 using identical manufacturing processes. The transparent conductive layers 13 and 13′ may be formed respectively on the laser blocking layers 12 and 12′ using identical manufacturing processes. The touch panel 1′″ is similar to that of the third embodiment and thus details thereof are not repeated herein.

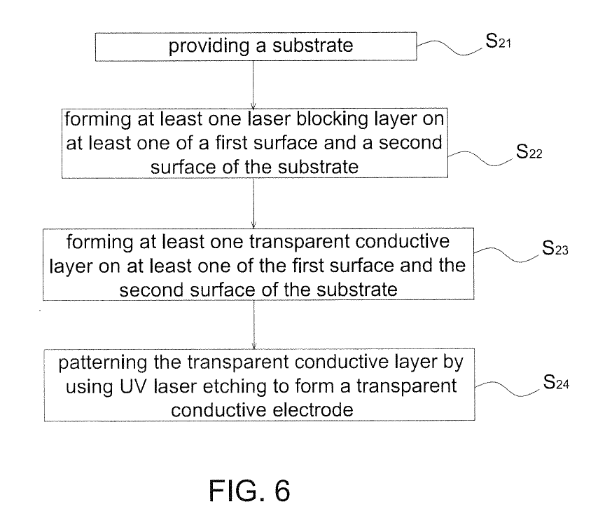

Referring to FIG. 6, it shows a flow chart of the manufacturing method of the touch panel according to the embodiment of the present disclosure including the steps of: providing a substrate (Step S₂₁); forming at least one laser blocking layer on at least one of a first surface and a second surface of the substrate (Step S₂₂); forming at least one transparent conductive layer on at least one of the first surface and the second surface of the substrate (Step S₂₃); and patterning the transparent conductive layer by using UV laser etching to form a transparent conductive electrode (Step S₂₄).

In the Step S₂₂, the laser blocking layer 111 may be formed only on one surface of the substrate 11 (as shown in FIGS. 1, 3 and 4) or formed on both surfaces of the substrate 11 (as shown in FIG. 5).

In the Step S₂₃, the transparent conductive layer 13 may be formed only on one surface of the substrate 11 (as shown in FIGS. 1 and 3) or formed on both surfaces of the substrate 11 (as shown in FIGS. 4 and 5), wherein when the laser blocking layer 111 is formed on one surface of the substrate 11, the transparent conductive layer 13 formed on the same surface is stacked on the laser blocking layer 111.

In the Step S₂₄, finally the UV laser beam 21 is used to perform the UV laser etching on the transparent conductive layer 13 so as to form transparent conductive electrodes, e.g. forming a plurality of parallel transparent conductive lines. When the transparent conductive layer 13 is formed on both surfaces of the substrate 11, the pattern of transparent conductive lines on both surfaces may be different or identical and the UV laser etching on the two transparent conductive layers may be performed simultaneously or sequentially. The electrode pattern and the etching sequence may be determined according to different applications.

As mentioned above, the manufacturing of a conventional capacitive touch panel needs a complex process and a higher cost. Therefore, the present disclosure further provides a touch panel manufactured by laser etching (FIGS. 1 to 5) and a manufacturing method thereof (FIG. 6) that does not use a mask in manufacturing and has a lower manufacturing cost. In addition, at least one laser blocking layer is formed on the touch panel of the present disclosure so as to prevent other components from being damaged during manufacturing.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A manufacturing method of a touch panel, comprising:
providing a substrate;
forming a laser blocking layer on at least one of a first surface and a second surface of the substrate;
forming a transparent conductive layer on at least one of the first surface and the second surface of the substrate; and
patterning the transparent conductive layer by using UV laser etching to form a transparent conductive electrode.

2. The manufacturing method as claimed in claim 1, wherein the laser blocking layer is formed only on the first surface, and the transparent conductive layer is formed on the laser blocking layer of the first surface or on the second surface.

3. The manufacturing method as claimed in claim 1, wherein the laser blocking layer is formed only on the first surface, and the transparent conductive layer is formed on the laser blocking layer of the first surface and on the second surface.

4. The manufacturing method as claimed in claim 1, wherein the laser blocking layer is formed on the first surface and the second surface, and the transparent conductive layer is formed on the laser blocking layer of the first surface and on the laser blocking layer of the second surface.

5. A touch panel, comprising:
a substrate;
at least one laser blocking layer formed on at least one of a first surface and a second surface of the substrate; and
at least one transparent conductive layer formed on at least one of the first surface and the second surface of the substrate, and a plurality of etching trenches having irregular edges being formed on the transparent conductive layer using UV laser.

6. The touch panel as claimed in claim 5, wherein the substrate is a soda glass substrate, an alkali free glass substrate, a PET substrate or a PI substrate.

7. The touch panel as claimed in claim 5, wherein the laser blocking layer blocks UV laser light of wavelength 150 nm to 400 nm.

8. The touch panel as claimed in claim 5, wherein the laser blocking layer blocks UV laser light of wavelength 200 nm to 300 nm.

9. The touch panel as claimed in claim 5, wherein a width of the etching trenches is between 20 μm and 100 μm.

10. The touch panel as claimed in claim 5, wherein a width of the etching trenches is between 30 μm and 50 μm.

11. The touch panel as claimed in claim 5, wherein the laser blocking layer is formed only on the first surface, and the transparent conductive layer is formed on the laser blocking layer of the first surface or on the second surface.

12. The touch panel as claimed in claim 5, wherein the laser blocking layer is formed only on the first surface, and the transparent conductive layer is formed on the laser blocking layer of the first surface and on the second surface.

13. The touch panel as claimed in claim 5, wherein the laser blocking layer is formed on the first surface and the second surface, and the transparent conductive layer is formed on the laser blocking layer of the first surface and on the laser blocking layer of the second surface.

14. The touch panel as claimed in claim 5, wherein a thickness of the substrate is between 0.1 μm and 2 μm.

15. The touch panel as claimed in claim 5, wherein a thickness of the laser blocking layer is between 100 and 10000 angstrom.
